(19) United States
(12) Patent Application Publication
(10) Pub. No.: US 2004/0174983 A1
(43) Pub. Date: Sep. 9, 2004

(54) Configurable call progress tones

(75) Inventors: Dan Olschwang, Tel Aviv (IL); Lior Yekutieli, Tel Aviv (IL); Benny Arbel, Tel Aviv (IL); Yaron Finkel, Yahud (IL); Eran Elias, Even Yehuda (IL); Gil Bul, Kadima (IL); Jim Levy, Hod Hasharon (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE LTD.

(21) Appl. No.: 10/739,163

(22) Filed: Dec. 19, 2003

Related U.S. Application Data
(60) Provisional application No. 60/452,526, filed on Mar. 7, 2003.
(60) Provisional application No. 60/502,228, filed on Sep. 12, 2003.

(51) Int. Cl. H04M 1/00; H04M 3/00

(52) U.S. Cl. 379/377; 379/372

(57) ABSTRACT

A method and a system for providing configurable call progress tones in a telephony session by identifying a receiver of the telephony session, selecting a tone in accordance with the preferences of the receiver and providing a configurable call progress tone of the selected tone.

This application claims the benefit of U.S. Provisional Patent Application No. 60/502,228, titled “Configurable Call Progress Tones” filed on Sep. 12, 2003, and of U.S. Provisional Patent Application No. 60/452,526 titled “Customized Ringback Tone” filed on Mar. 7, 2003 the disclosures of which are incorporated by reference in their entirety.

### BACKGROUND OF THE INVENTION

1. Field of the Invention

This invention relates to a method and system for providing configurable call progress tones in a telephony system.

2. Description of the Related Art

In the course of a telephone call, signaling events occur between subscribers and/or switch devices. The state of a line is monitored, and whenever the state changes, the switch devices exchange signaling messages notifying this change. Call progress tone signals provide information regarding the status or progress of a call to customers, operators, and connected equipment. The most common call progress tones are dial tone, busy tone and ringback tone. However, other tones can also exist, such as call waiting tone, reorder and others.

Several publications are known that describe the exchange of the ringback tone with a configurable ringback tone used for advertisement.

For example WO 00/49793 (“Advertising method by using ring-back tone”, assigned to Kim Kang Suk, published in 2000) discloses an advertising method by using a ring-back tone. According to WO 00/49793, a controller employed in a sender-side switching system recognizes a sender's telephone number and a receiver's telephone number dialed at the sender's telephone set. Then the receiver's telephone number is transmitted to a receiver-side switching system at a calling stage. The receiver-side switching system checks the state of the receiver's telephone, e.g., ready or busy, and, subsequently, sends, e.g., a ringback tone in conformity to the state to the sender-side switching system. The sender-side switching system receives the ring-back tone. In case the ring-back tone is a busy tone, the sender-side switching system forwards the busy tone to the sender's telephone set. Otherwise, that is, the ring-back tone is a ringing tone which implies that the receiver's telephone is ready to receive a call, the sender-side switching system searches registered member information by consulting a database linked to the controller and checks if the receiver's telephone number matches a registered member in the database.

If the sender is determined not to be a registered member, the sender-side switching system forwards the ring-back tone; otherwise, it sends a predetermined advertisement message stored in an advertisement memory to the sender's telephone set. If a response, e.g., a hook-off, from the receiver's telephone is perceived or if the sender terminates the call, the sender-side switching system stops the sending of the advertisement message.

Another conventional method described in WO 00/62524 (“Ring back tone/busy tone selection-type mobile telephone”, assigned to Han Dong Shik, published in 2000) discloses a ring back tone/busy tone selection-type communication in which instead of conventional tones, a music signal and an information voice signal is transmitted to the caller.

JP 11,275,232 (“Telephone switching network system”, assigned to NTT Mobil Commun Network Inc., published in 1999) identifies the need to provide a system capable of sending a high-efficiency voice coded ring back tone to a line by transmitting music or voice set by a customer to the terminal of a communicating party as a customer-original ring back tone. JP 11,275,232 discloses a call controller that instructs a voice storage calling device to transmit a ring back tone through a communication line to another exchange. The voice storage calling device selects a ring back tone corresponding to a callee and sends the selected ring back tone to a call originating terminal. The customer can transmit any music or voice to the terminal of a party as a customer-original ring back tone.

Another conventional system described in WO 01/06735 (“Method and device for generating voice/text/image commercial information ringback tone during communication wait”, assigned to Ringfree Co. LTD., published in 2001) discloses a device and a method of generating voice/text/image commercial information while the user waits for communication connection.

In the related art, there are also publications dealing with playing games using telephones as terminals. For example, U.S. Pat. No. 6,512,415 (“Telephonic-interface game control system”, assigned to Ronald A. Katz Technology Licensing LP, published on 2003) discloses a control system that interfaces a multiplicity of individual terminals through a telephone network facility accommodating various game formats. At the terminals, callers are prompted by voice-generated instructions to provide digital data that is identified for positive association with a caller and stored, as for processing. Calls are conditionally accepted based on a test of preliminary identification data (ANI or DNIS). Computer generated designations are assigned to callers and are stored. Questions for game use are stored in banks, classified by the level of difficulty for selection according to various formats. Specific game formats accommodate various time criteria and caller selection of the level of risk. Caller data is stored in cells along with statistical and identification data; also, key contest data is held accessible in a cache memory for reporting.

Also, publications exist that deals with recording audio from wireless or wired communication devices. For example, U.S. Pat. No. 6,222,909 (“Audio note taking system and method for communication devices”, assigned to Lucent Technologies Inc., published on 2001) discloses an audio note taking system and method that permit a user to record audio information during a conversation on a wireless or wired communications device and distribute the information to other users in an efficient and accurate manner by working in concert with other types of communication and information devices, such as voice mail and electronic mail servers.

Telephony systems were integrated in the art with the Internet, allowing, among the rest, management and control of stored telephony messages such as voice mail messages. U.S. Pat. No. 6,031,896 (“Real-time voicemail monitoring and call control over the Internet”, assigned to GTE Laboratories Incorporated, published in 2000) discloses a communication system that provides call connections and voice mail service to telephone devices. With this system, a called party has the ability to monitor and control an incoming voice mail message, made by a calling party, which is to be recorded onto a voice mail system.

Furthermore, U.S. Pat. No. 6,192,118 (“Computer telephone system and method having a graphical user interface”, assigned to Davox Corporation, published on 2001) discloses a telecommunications system that provides for telephone functions to be accessed through client computer system. A server computer system provides telephony services, database services and access to E-mail, voice mail, video conferencing and facsimile systems. A graphical user interface is presented to a user to allow the user to perform a large number of functions and to access databases of information associated with calling and called parties.

Other publications exist that deals with integration of video and other multimedia formats with voice mail and telephony systems. Such a publication is, for example, WO 03/055191 (“Voice mail service where the caller can choose among different message types”, assigned to TELEFONAKTIEBOLAGET LM ERICSSON, published in 2003). WO 03/055191 presents a method to provide a more enhanced voice message system to subscribers of a voice message service, where a calling party can receive more detailed information about the called subscriber and in different kind of formats. This is done by giving the calling party the opportunity to choose between to receive different types of messages. However, all of these publications described above fail to provide a user with wide variety of choices and flexibility that he may desire in replacing the conventional progress tones with personalized ones.

All of the above mentioned publications are incorporated herein by reference.

### SUMMARY OF THE INVENTION

To solve the above-described problem, it is an aspect of the present invention to provide a system and a method capable of providing configurable call progress tones in a telephony session so as to give the user flexibility and wide variety in selecting the progress tones. This method comprises identifying a receiver of said telephony session; selecting a tone in accordance with preferences; said preferences are dependent upon at least said receiver identity, and providing a configurable call progress tone of said selected tone.

To further solve the above described problem, it is an aspect of the present invention to provide a method for providing configurable call progress tones in a telephony session comprising: identifying an originator of said telephony session; selecting a tone in accordance with preferences; said preferences are dependent upon at least said originator identity, and providing a configurable call progress tone of said selected tone after paging to a receiver.

In yet a further aspect of the present invention, a method for providing configurable call progress tones in a telephony session comprises identifying at least two parties of said telephony session; selecting a tone in accordance with preferences; said preferences are dependent upon at least two of said party identities; and providing a configurable call progress tone of said selected tone.

In another aspect of the present invention a method for providing configurable call progress tones in a telephony session comprises: identifying at least two parties of said telephony session; selecting a tone in accordance with preferences; said preferences are dependent upon at least two of said party identities; and providing a configurable call progress tone of said selected tone.

In yet a further aspect the present invention a method for providing configurable call progress tones in a telephony session comprises: identifying a receiver of said telephony session; identifying a receiver status of said telephony session; selecting a tone in accordance with preferences; said preferences are dependent upon at least said receiver identity; providing a configurable call progress tone of said selected tone; and providing in association with said configurable call progress tone a conventional call progress tone in accordance with said receiver status.

In yet a further aspect of the present invention a method for providing configurable call progress tones in a telephony session comprises: identifying an originator of said telephony session; identifying a receiver status of said telephony session; selecting a tone in accordance with preferences; said preferences are dependent upon at least said originator identity; providing a configurable call progress tone of said selected tone after paging to a receiver; and providing in association with said configurable call progress tone a conventional call progress tone in accordance with said receiver status.

In yet another aspect of the present invention a system in association with a switching system for providing configurable call progress tones in a telephony session comprises: a module identifying a receiver of said telephony session; a module selecting a tone in accordance with preferences; said preferences are dependent upon at least said receiver identity; and a module providing a configurable call progress tone of said selected tone.

In yet a further aspect the invention provides a system in association with a switching system for providing configurable call progress tones in a telephony session, the system comprising: module identifying an originator of said telephony session; module selecting a tone in accordance with preferences; said preferences are dependent upon at least said originator identity, and module providing a configurable call progress tone of said selected tone after paging to a receiver.

In yet a further aspect the invention provides a system in association with a switching system for providing configurable call progress tones in a telephony session, the system comprising: a service logic module identifying at least two parties of said telephony session; a tone providing module selecting a tone in accordance with preferences; said preferences are dependent upon at least one of said party identities; and a communication module providing a configurable call progress tone of said selected tone after paging to a receiver.

In yet a further aspect the invention provides a system in association with a switching system for providing configurable call progress tones in a telephony session, the system comprising: a module identifying at least two parties of said telephony session; a module selecting a tone in accordance with preferences; said preferences are dependent upon at least two of said party identities; and a module providing a configurable call progress tone of said selected tone.

In yet a further aspect the invention provides a system in association with a switching system for providing configurable call progress tones in a telephony session, the system comprising: a module identifying a receiver of said telephony session; a module identifying a receiver status of said telephony session; a module selecting a tone in accordance with preferences; said preferences are dependent upon at least said receiver identity; a module providing a configurable call progress tone of said selected tone; and a module providing in association with said configurable call progress tone a conventional call progress tone in accordance with said receiver status.

In yet a further aspect the invention provides a system for providing configurable call progress tones in a telephony session, the system comprising: a switch device receiving a call from an originator in a telephony session and transmitting tones to a receiver; an application server receiving an inquiry from said switch device; and a database storing said originator identity and corresponding preferences, wherein said application server identifies said originator and a receiver status and transmits a configurable call progress tone of said selected tone via said switch after paging, to said receiver, and a conventional call progress tone in accordance with the receiver status.

In yet a further aspect the invention provides a tones providing system for providing configurable call progress tones in a telephony session, the tones providing system is configured to perform at least the following: identify a receiver of said telephony session; select a tone in accordance with preferences; said preferences are dependent upon at least said receiver identity, and provide a configurable call progress tone of said selected tone.

Another aspect of the present invention provides a system for providing configurable call progress tones in a telephony session, the system comprising a switch for receiving a call originated from a terminal; a storage member storing at least one preference dependent upon a terminal identity; and a server identifying at least one said preference using said storage member; wherein said switch device sends a query to said server to select a tone in accordance with said at least one preference, and wherein said server provides a configurable call progress tone of selected said tone to said terminal via said switch.

A further aspect of the present invention provides an article of manufacture comprising a program readable by a computer and embodying one or more instructions executable by the computer to perform a method, comprising: identifying a receiver of said telephony session; selecting a tone in accordance with preferences; said preferences depend upon at least said receiver identity; and providing a configurable call progress tone of said selected tone.

### BRIEF DESCRIPTION OF THE DRAWINGS

In order to understand the invention and to see how it may be carried out in practice, illustrative, non-limiting embodiments will now be described, with reference to the accompanying drawings, in which:

FIG. 1 illustrates exemplary periods along a telephony session, according to one of the embodiments of the invention.

FIG. 2 is a block diagram illustrating a switching system integrating a tones providing system operating in an Intelligent Network configuration, according to an embodiment of the invention.

FIG. 3 is a block diagram showing a tones providing system, according to one of the embodiments of the invention.

FIGS. 4A and B are a flow chart illustrating provisioning preferences, in accordance with one of the embodiments of the invention.

FIG. 5 is a signaling flow diagram characterizing a call to a receiver who is subscribed to the tones providing service operating in IN mode, according to one of the embodiments of the invention.

FIG. 6 is a flow chart illustrating the operating steps of a switching function operating in IN mode, according to one of the embodiments of the invention.

FIG. 7 is a flow chart illustrating the operating steps in a tones providing system, according to an embodiment of the invention.

FIG. 8 is a block diagram illustrating a tones providing system operating in combination with a voice mail system according to an embodiment of the invention.

FIG. 9 is a block diagram showing a tones providing system operating in service node configuration according to an embodiment of the invention.

### DETAILED DESCRIPTION OF THE INVENTION

The present invention will now be described in detail by describing illustrative, non-limiting embodiments thereof with reference to the accompanying drawings.

The present invention relates to a method of playing a configurable call progress tone while waiting for communication on a telephone line. It should be noted that the term “telephone” refers to wired telephones, cellular telephones, satellite telephones or other types of communication means applicable for audio and/or video communication.

It should also be noted that in accordance with the background of the invention, the term “call progress tone” includes, for example, ringback tone, busy tone, call waiting tone etc. This is non-limiting and other types of call progress tones can be covered by the definition when applicable. According to an embodiment of the invention, the call progress tones are divided into two general groups, one of which is “failed call progress tone”, including for example busy tone or reorder tone. A failed call progress tone indicates that the communication could not be completed and the call originator should not wait for the call receiver to answer. The other group is referred to, hereinafter as “pending call progress tone”, i.e., this group includes tones characterizing a call that was not answered yet. A call originator that hears a pending call progress tone can wait for the receiver to answer the telephone. Among the pending call progress tones are, for example, the ringback tone and the call waiting tone.

Before continuing with the description of an embodiment of the invention, it should be noted that at least two parties participating in a telephone call, each party is connected through a switch device. It is noted that a switch device can be comprised of more than one unit as appropriate. Sometimes the parties are connected to the same switch device, and sometimes more than one switch device is involved. That is, there is at least one switch device involved in a call. The switch devices involved in a call constitute together a switching system. It is the switching system that commonly provides call progress tones (such as busy tone, ringback tone, call waiting tome etc.). Call progress tones are predetermined, for example, by the Telephony Company or by the producer of the switch devices composing the switching system.

Call progress tones normally provided by the switching system are referred to, hereinafter, as “conventional call progress tones” (terms such as “conventional failed call progress tone”, “conventional pending call progress tone”, “conventional ringback tone”, “conventional call waiting tone” etc. are used accordingly). Hereinafter, a “conventional switching system” is a switching system that provides conventional call progress tones.

The description below refers to telephone calls with two parties, one is a call originator (or shortly, “originator”) and the other is a receiving party (or shortly, “destination” or “receiver”). However, those versed in the art can appreciate that this is non-limiting, and calls wherein more than two parties are participating are also applicable. For example, a teleconference call can involve more than two parties. In the same way, the switching system is composed from at least an originating switch and a receiving switch (in certain cases the originating switch and the receiving switch can be the same switch). However, sometimes other switches are involved as well.

Before continuing with the description below, it is also mentioned that when an originator dials to a receiver, a session is started. This session is typically terminated, for example, when the parties end their conversation and disconnect the call. According to a different example, if the receiver's telephone is busy, the originator hears a conventional busy tone provided by the switching system. This busy tone is considered as part of the session. When the switching system stops providing the busy tone this can be considered as terminating the session.

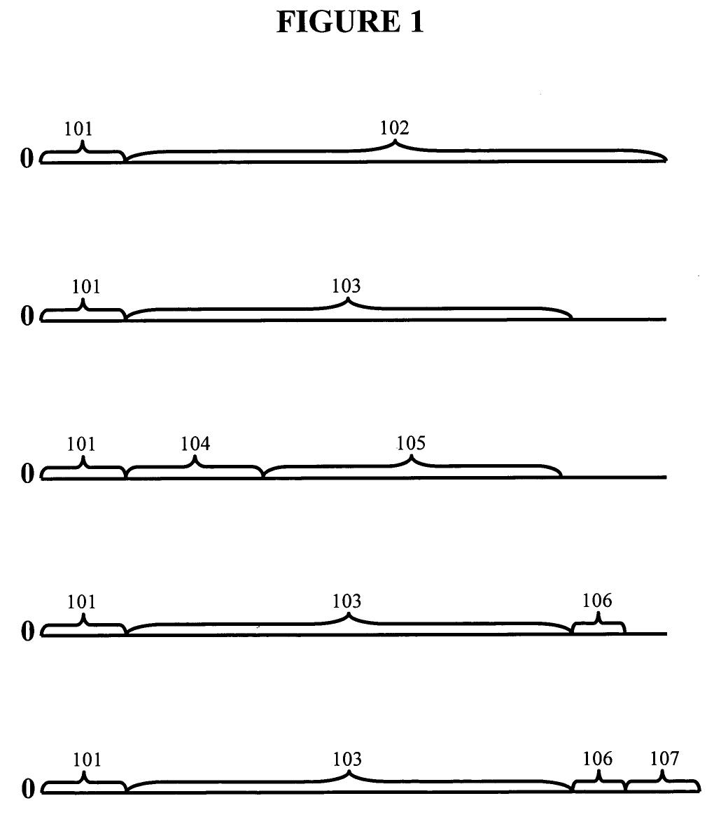

FIG. 1 illustrates exemplary periods along a telephony session, according to an embodiment of the invention. The session begins at time point “zero” (0) that is considered as the time point in which the call originator terminated dialing. After dialing, via a conventional switching system, the call originator usually hears silence throughout a short period referred to hereinafter as “silence period” (101), during which the originating switch can, for example, try to connect to the receiving switch. In many cases this silence period is short enough to be unrecognizable by the call originator, and in others the silence period can be absent. For example, if the call originator and the receiver are both connected to the same switching system, sometimes the silence period can be substantially equal to zero. Therefore the silence period is considered by this invention as being substantially equal or longer than zero.

There are additional periods during a telephony session, affected by a receiver status. For example, after the silence period, if the communication can not be completed (such as when the receiver's line is busy or, in a cellular telephony system, when the receiver's telephone cannot be located) the originator conventionally starts hearing a busy tone for a time period (“busy period”, 102) determined by the switch. After the busy period the session is terminated.

On the other hand, if the receiver's telephone is found to be available (in other words: the receiver status is “ringing”), the call originator will hear a pending call progress tone. The pending call progress tone is heard throughout a period determined by the switch (“waiting period”, 103), and after which, if the receiver does not answer the call, the session is terminated or is answered by an automatic response system, or is routed to a different destination telephone number, etc.

The waiting period 103 terminates also when the receiver answers the call, therefore its duration is not constant. It should be noted that the silent period 101, the busy period 102 and the waiting period 103 are set by the switching system, and they can be equal or different in duration as appropriate to the configuration of the switching system used. Also, different waiting periods can be set by the switching system for ringback tone, call waiting tone etc. This is illustrated in FIG. 1 by having a busy period 102 and a waiting period 103 different in length. It is noted that although in FIG. 1 the busy period 102 is longer than the waiting period 103, this is provided by way of a non-limiting example only, and there is no connection between the two periods.

According to an embodiment of the invention, it is possible to replace a conventional call progress tone with a configurable call progress tone, referred to shortly hereinafter as “configurable tone”. The configurable tone can be composed of multimedia content, and it is not limited to audio. For example, a configurable tone can be composed of audio (contents such as music, jokes, information of any kind, a piece recorded by a subscriber or even a combination thereof), video (contents such as movies or parts thereof, personally taken films, video clips or a combination thereof), interactive programs (such as games), or a combination thereof.

The configurable tones are played by a tones providing system coupled to or being part of the switching system, the tones providing system provides a tones providing service.

Back to FIG. 1, it is possible to replace the conventional call progress tone heard throughout the busy period 102, or the conventional call progress tone heard through the waiting period 103. However, it is also possible to replace the conventional call progress tone only throughout parts of any of the periods 102 and 103. For example, in accordance with an embodiment of the invention the waiting period 103 can be divided into two separate periods referred to as a “training wait period” 104 and a “configurable tone wait period” 105. In order to avoid confusing the call originator, who is used to hear a conventional pending call progress tone, in accordance with an embodiment of the invention a conventional pending call progress tone can be provided throughout the training wait period 104, and the tones providing system can provide a configurable tone throughout the configurable tone wait period 105.

Here it should also be noted that the relation in duration of the two periods 104 and 105 can vary as applicable, and each of the two periods 104 and 105 can be substantially equal or longer than zero. It should also be mentioned that other ways exist for training users to the tone providing service, such as providing a conventional call progress tone together with a configurable tone, thus constituting a “composite training tone”. A combination of the two training methods is also possible, for example, when the composite training tone is provided during the training wait period 104 and the configurable tone alone is provided during the configurable tone wait period 105.

Thus, a configurable tone can be provided in association with a conventional call progress tone, wherein the conventional call progress tone can be provided as preceding in time to the configurable tone, wherein the configurable tone can be provided as preceding in time to the conventional call progress tone, wherein the conventional call progress tone and the configurable tones are interleaved or when the conventional call progress tone is superimposed on the configurable tone. However, this is non-limiting and or any other combination or relative timing of the conventional and configurable tones can exist as well.

If the receiver answers the call, there will be a “connection period” 106, during which the parties are connected. This period is, of course, characterized by a varying duration, determined by the time through which the parties hold the line connected, and it can be of any duration substantially equal to zero or longer. It is therefore noted that in FIG. 1 this connection period 106 is illustrated, but its illustrated duration is non-limiting.

It is noted here that the invention also applies to those cases where at least one of the parties participating in a call is a non-human party such as an automatic dialer, voice mail system, a MODEM or a facsimile machine. Thus, the term “party” refers to both a human and a non-human party, unless specifically noted otherwise.

Normally, after disconnecting a session, the parties hear silence or any tone configured by the switching system. According to another embodiment of the invention, an “after session period” 107 is defined. The after session period lasts for duration appropriate to the case, as configured for example in or by the switching system. The after session period can be substantially equal to zero or longer. According to the embodiment throughout the after session period 107 at least one of the parties can hear a configurable tone.

Further according to another embodiment of the invention, the configurable tone providing service is a service provided to subscribed members constituting configurable tones subscribers. Hereinafter, configurable tones subscribers are referred to, shortly, as “subscribers”, therefore it should be clear that unless specifically noted, the term “subscribers” refer to “configurable tones subscribers”. In one embodiment, a subscriber can determine what call originators will hear when dialing his number. For example, a subscriber can determine that every call originator dialing his number will hear a joke about busy telephone lines during the busy period 102, and a Beatles' song during the waiting period 103. Another subscriber can determine, for example, that during the busy period 102 call originators will hear the conventional busy tone, while during the wait period 103 they will hear a piece composed by Beethoven. Yet another subscriber can chose to play, for example, a conventional busy tone during the busy period 102, a conventional pending call progress tone during the training wait period 104, and a local weather forecast during the configurable tone wait period 105. These examples are non limited to audio configurable tones, and in a videoconferencing system, for example, the configurable tones subscriber can determine that call originators will watch a certain video clip during the waiting period 103. It should also be noted that the examples above are by no means limiting.

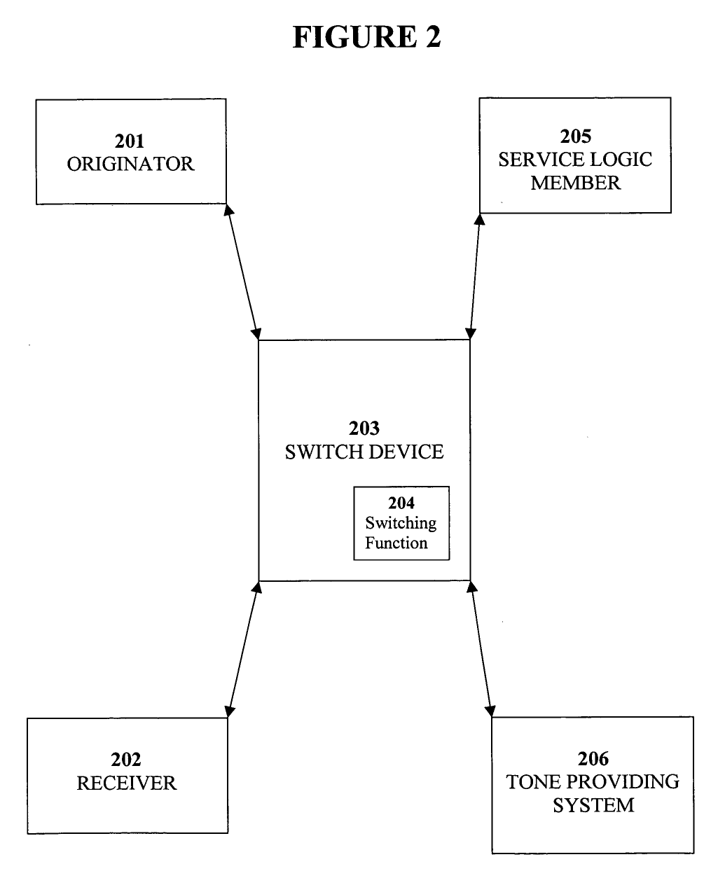

FIG. 2 illustrates a block diagram of a switching system integrating a tones providing system operating in an Intelligent Network (hereinafter, “IN”) configured according to one of the embodiments of the present invention. When a call originator 201 calls a receiver 202, communication is generated through a switching system including at least one switch device 203 (hereinafter referred to, shortly, as “switch”). The switch 203 includes a switching function 204. Those versed in the art can appreciate that a Service Switching Function (SSF) or a Service Switching Point (SSP) are known exemplary embodiments of such a switching function 204. The switch 203 is coupled to a service logic member 205, such as a Service Control Point (SCP), and to a tone providing system 206.

When the originator 201 calls the receiver 202, a session is started, wherein signaling events characterizing the call arrive at the switch 203, operating the switching function 204. According to the embodiment, the switching function 204 initiates a series of transactions with the service logic member 205. Communication between the switching function 204 and the service logic member 205 can be performed, for example, by using the Intelligent Network Application Protocol (INAP), as known to those skilled in the art. However, this is a non-limiting example, and any other way of communication is also applicable.

The service logic member 205 can be coupled to a real-time database that stores customers' records and logic rules for controlling the Network's functionality. When accessed by an inquiry from the switching function 204, the service logic member 205 executes at least one of a range of software routines customized for particular applications, as known to those versed in the art. According to the embodiment, among those routines executed by the service logic member 205 is querying if the receiver 202 is a subscriber or not. The result of this query is transmitted back in reply to the inquiry of the switching function 204.

It should be noted that the switching function 204, the service logic 205 and any other module can identify the receiver 202, for example, according to the number dialed by the originator 201. If the receiver 202 is a subscriber, the switching function 204 further directs control to the tones providing system 206. The tones providing system 206 identifies the receiver 202 and retrieves the subscriber's preferences.

Sometimes the tones providing system 206 can also identify the originator 201, for example according to a Caller ID (CLI) provided by the switch 203. In those cases when the call originator 201 is identified, according to one embodiment of the invention it is possible to select and provide a personalized configurable call progress tone aimed to the specific call originator 201. The identification of the configurable tone selected to be provided as a configurable call progress tone (personalized or not) is referred to hereinafter as a selected tone. The selected tone defines content to be provided so that the originator 201 can hear, see or interact therewith.

It may be recalled that the content can be, for example, audio, video, text or any other media that can be provided, transferred to the call originator 201 and played to him/her replacing a conventional call progress tone. The content can be also interactive content, such as a game played by the call originator 201 while he waits for the receiver 202 to answer the call, or a combination thereof. However, the examples provided are non-limiting, and any other form, type or media appropriate to replace conventional call progress tones is also applicable.

After selecting a tone (giving rise to selected tone) and retrieving the respective content, the tones providing system 206 starts providing the selected tone as the configurable call progress tone. Providing the tone is done, for example by streaming the content forming an audio (or video) configurable tone, or by executing code being part of content defining interactive content, as known to those versed in the art. The tones providing system 206 then notifies the switching function 204 that it has started providing a selected tone. The switching function 204 pages the receiver, and afterwards (i.e., in a duration referred to as the page-delay period, which can be substantially equal to zero or longer in duration) the switching function 204 connects the tones providing system 206 to the originator 201, to receive the selected tone. When the receiver answers the call, the switch 203 notifies the service logic member 205 that the call was answered. The service logic member 205, which recognizes that the receiver is a subscriber instructs the switching function to stop providing the configurable tone, and the switching function 204 disconnects the tones providing system 206, and connects the receiver 202 to the call originator 201.

It should be noted that FIG. 2 illustrates a tones providing system operating in a call between two parties (201 and 202). Nevertheless, this is non-limiting, and the tones providing system can operate when more than two parties are participating in a call process, for example, in a multi parties conference call.

Those versed in the art will readily appreciate that the block diagram of FIG. 2 is by no means binding and accordingly one or more of the components thereof may be modified and/or others may be added, all as required and appropriate depending upon the particular application.

The following example demonstrates the utilization of having personalized configurable tones: a receiver 202 who is a configurable tones subscriber is identified according to her telephone number—for example, 111111 (hereinafter the number 111111 is used to refer to the receiver). The receiver 202 111111 can set a configurable tone that is the Beatles' song “Let It Be” to replace the conventional ringback tone. Call originators calling 111111 will hear, therefore, Let It Be when waiting for the receiver to answer the telephone. However, 111111 knows that her mother (whose telephone number is 222222) likes hearing classical music, and her favorite piece is Bach's “Ave Maria”. Therefore she can set Ave Maria as a personalized configurable tone heard whenever 222222 is detected as the call originator. According to this example, the mother will hear Ave Maria, while the other call originators will hear Let It Be.

Nonetheless, 111111 might also be waiting for an important call from a business associate. The business associate's telephone number is 333333. The receiver 111111 knows that her telephone is going to be busy for the upcoming hours because of a long conversation she is going to have. Yet, she wants to tell her associate (i.e., 333333) that she wants them to meet in the evening in a famous restaurant named “La Restauranta”. In this case 111111 can record a personalized message saying “Dear associate, I am currently busy but I hope to meet you at 8 o'clock at La Restauranta in the center of town”, constituting a recorded personalized configurable tone. Then, 111111 can set the recorded personalized configurable tone as the personalized configurable tone for the busy period 102 for 333333. When the tones providing system identifies a call from 333333 to 111111, instead of hearing a conventional busy tone the call originator will hear the recorded personalized configurable tone.

It should be noted that the disclosed embodiments, as well as the previous example are by no way limited to the numbering scheme of the receiver, the mother and the associate. It is appreciated that any other numbering scheme or a combination thereof is applicable. It should also be noted that the invention is applicable also when using Universal Personal Numbering (UPN), i.e., when the numbers are assigned to individuals rather then to equipment or geographical locations (hereinafter, “conventional telephone numbers”). As known to those versed in the art, when using UPNs, telephone service subscribers retain their UPN numbers, regardless of whether they move to a different location or change their telecom service provider. The invention is also applicable when using a combination of conventional telephone numbers and UPNs, and any other numbering scheme.

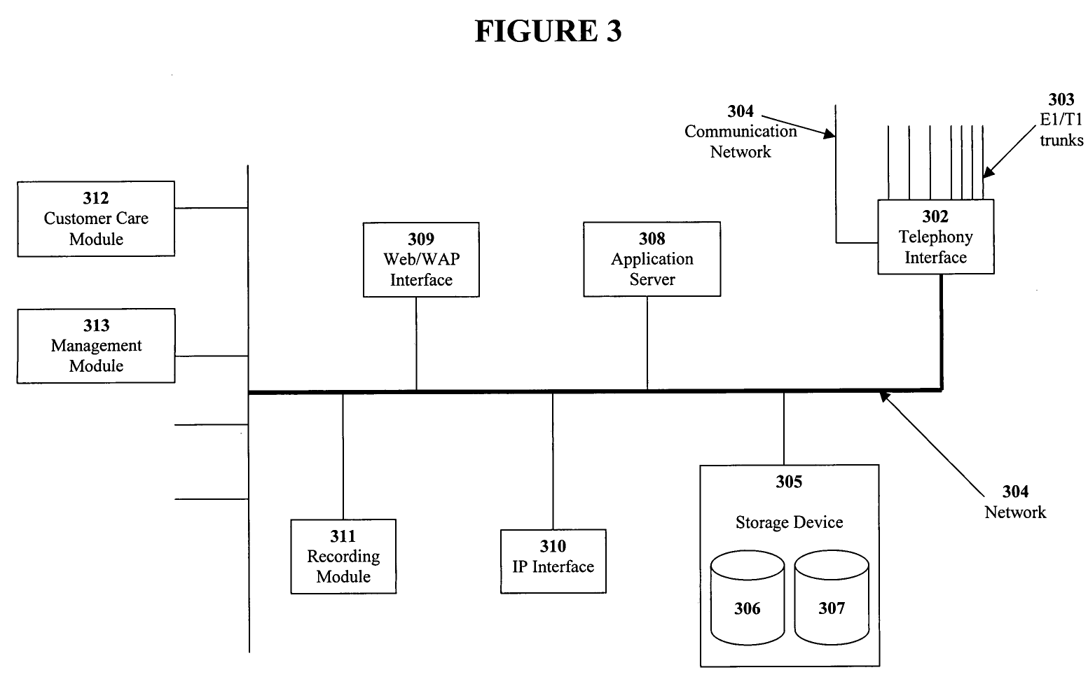

FIG. 3 illustrates a block diagram of a tones providing system 206, according to one embodiment of the invention. According to the illustrative embodiment, the tones providing system 206 is a modular system composed of several modules communicating through a network 301, e.g., LAN such as Ethernet network. The tones providing system 206 connects to the switching system (not shown) through a telephony interface 302. The telephony interface can connect to E1/T1 trunks 303 for providing content to call originator, or it can connect by means of a computer communication network 304 to the switching system for streaming the content thereto. The switching system (not shown) is connected to the E1/T1 trunks, on which the content can be transmitted to the call parties. The communication network 304 is used also to receive requests from the switching function 204.

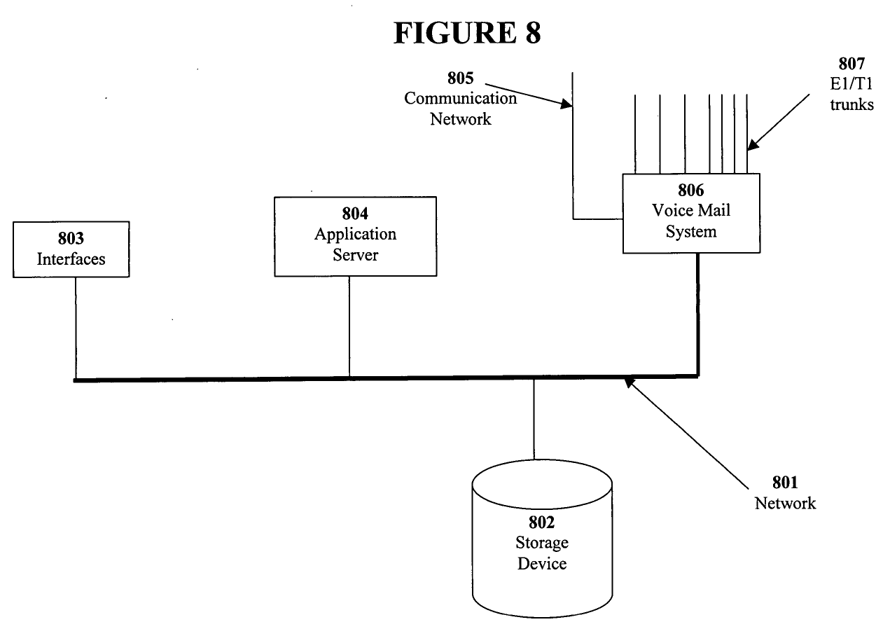

The tones providing system 206, is coupled also to a storage device 305 for storing content used for configurable tones and subscribers' preferences. However, this is non-limiting, and the storage device can be divided to more then one storage devices, for example, one for storing subscribers' preferences (therefore constituting “preferences storage” 306) and one for storing content (therefore constituting “content storage” 307). As will be explained below, with reference to FIG. 8, the tones providing system 206 can be coupled only to a preferences storage 306, wherein the content storage 307 can sometimes be coupled to other systems, external to the tones providing system 206, such as a voice mail system.

In the tones providing system 206, preferences and content retrieval is managed by an application server 308. The application server 308 can store new preferences (in a process referred to as “provisioning”) and new content, and it can also be used for selecting tones and retrieving respective content, when the switching system requests it to do so, as previously explained with reference to FIG. 2.

In addition, the tones providing system 206, can include different interface modules such as web/WAP interface 309, used for example, for provisioning through a web browser or through a mobile unit using WAP. Another optional interface module is an IP interface 310 used for IP communication with the tones providing system 206 and also for provisioning or for managing the system.

A recording module 311 can be used for recording content such as recorded configurable tones (personalized or not). In addition it is possible to couple to the tones providing system 206 other modules such as a customer care module 312, a management module 313 for managing the tones providing system 206, etc.

Those versed in the art will readily appreciate that the block diagram of FIG. 3 is by no means binding and accordingly one or more of the components thereof may be modified and/or others may be added, all as required and appropriate depending upon the particular application.

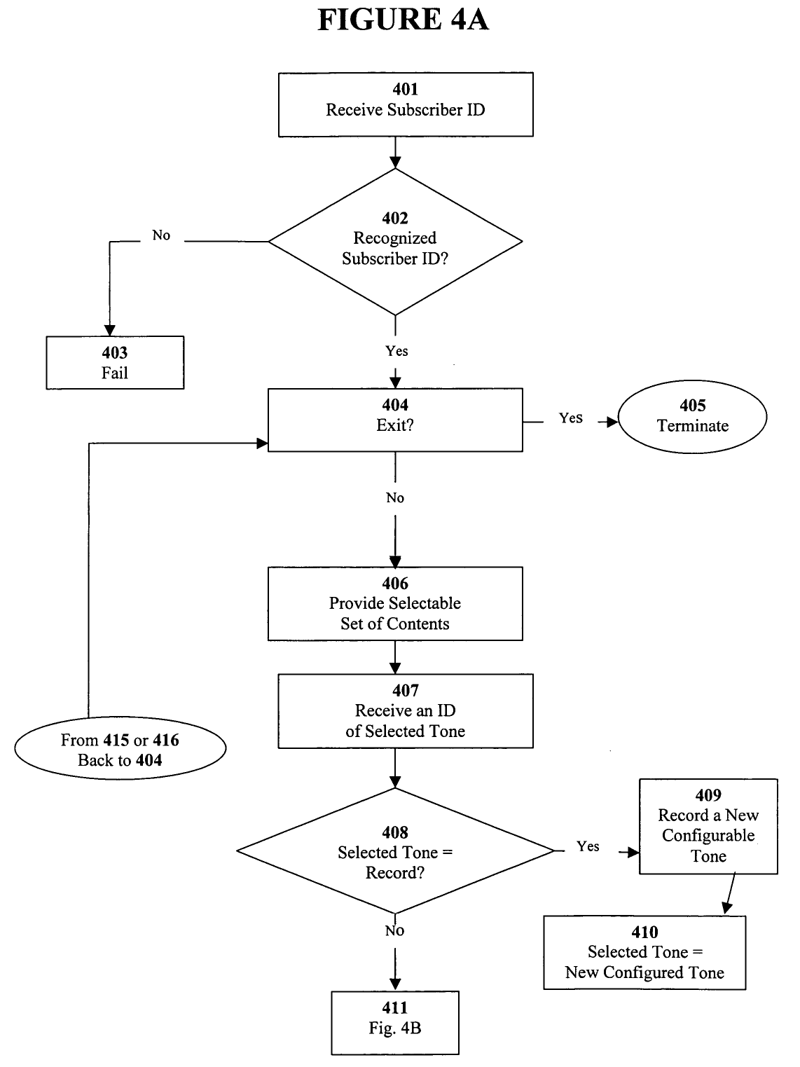

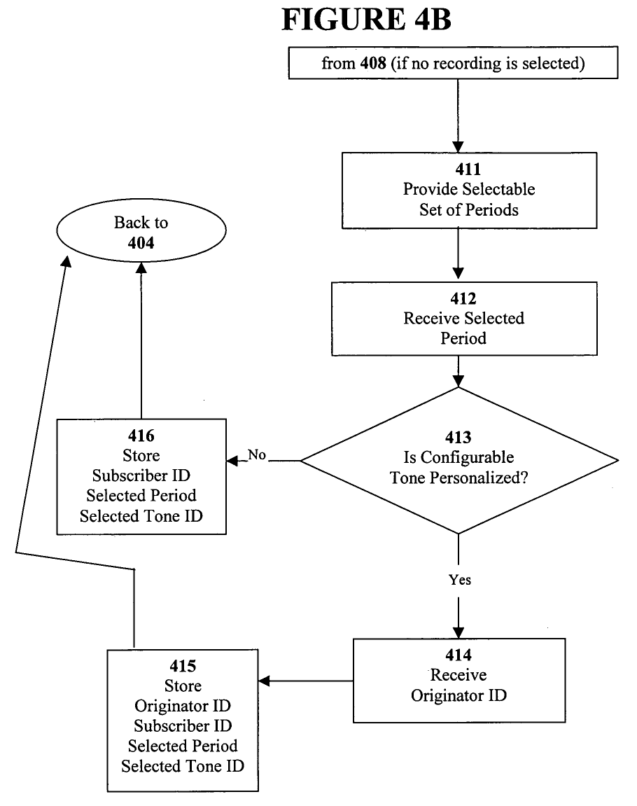

Before providing additional functional details as to how certain embodiments of the invention operate in combination with switching systems, attention is drawn to FIGS. 4A and 4B that illustrates a flow chart of provisioning preferences, in accordance with one of the embodiments of the present invention. According to this embodiment, and also with reference to FIG. 3, provisioning can be performed, for example, by the application server 308. However, those who are versed in the art can appreciate that other embodiments can have a dedicated server for doing so (not shown in FIG. 3).

In order to start providing preferences for a subscriber, first the subscriber ID should be provided (401), as shown in FIG. 4A. If the ID provided can't be recognized in 402 as a subscriber ID, the provisioning fails 403. It is noted, however, that different embodiments can list unrecognized IDs as new subscriber IDs, instead of failing.

The provisioning processor enables to enter settings for more than one configurable tone, as long as the operator does not choose to terminate the process. 404 performs this loop, and the process is terminated on 405 when the operator chooses to exit.

When setting a configurable tone, on 406 the processor provides to the operator a selectable set of contents and receive an ID of a selected tone, 407, as selected by the operator. It should be noted that the selectable set of contents could include the option “record a configurable tone”. That is, by identifying on 408 that the operator selected to record a configurable tone, the provisioning processor records a new configurable tone, 409, adding this new configurable tone to the selectable set of contents (i.e., providing an ID to the new tone). The ID of the new tone is set as the selected tone, 410.

Now the provisioning processor provides the operator with a selectable set of periods, 411 (see FIG. 4B), from which he is expected to select the period during which the selected tone is to be heard. On 412 the operator's selection is received.

Further on 413, the provisioning processor determines whether the operator wants to set a configurable tone, which is personalized or not. When setting a personalized configurable tone, the provisioning processor needs to receive an originator ID, 414. The combination of subscriber ID, originator ID, selected period and selected tone ID is stored, 415, in the preferences storage 306. On the other hand, when setting a configurable tone that is not personalized, the operator does not need to provide an originator ID. Therefore, the provisioning processor can continue directly to 416, for storing the combination of subscriber ID, selected period and selected tone ID in the preferences storage 306.

Now the provisioning processor returns to 404, being ready to receive a new setting for a configurable tone, or to exit and terminate the provisioning process.

In FIG. 4A, 409, the provisioning processor performed recording of a newly recorded tone. In this stage, for example, the operator can choose to record himself speaking or singing, he can provide a short video clip, or he can select a caraoke, combining a prerecorded tone and a newly recorded content etc. Those versed in the art can appreciate that there are ways known in the art for recording of multimedia data from telephony and computer communication ports, and ways for providing such multimedia data are also known.

The description turns now for providing additional details as to how certain embodiments of the invention operate in combination with switching systems.

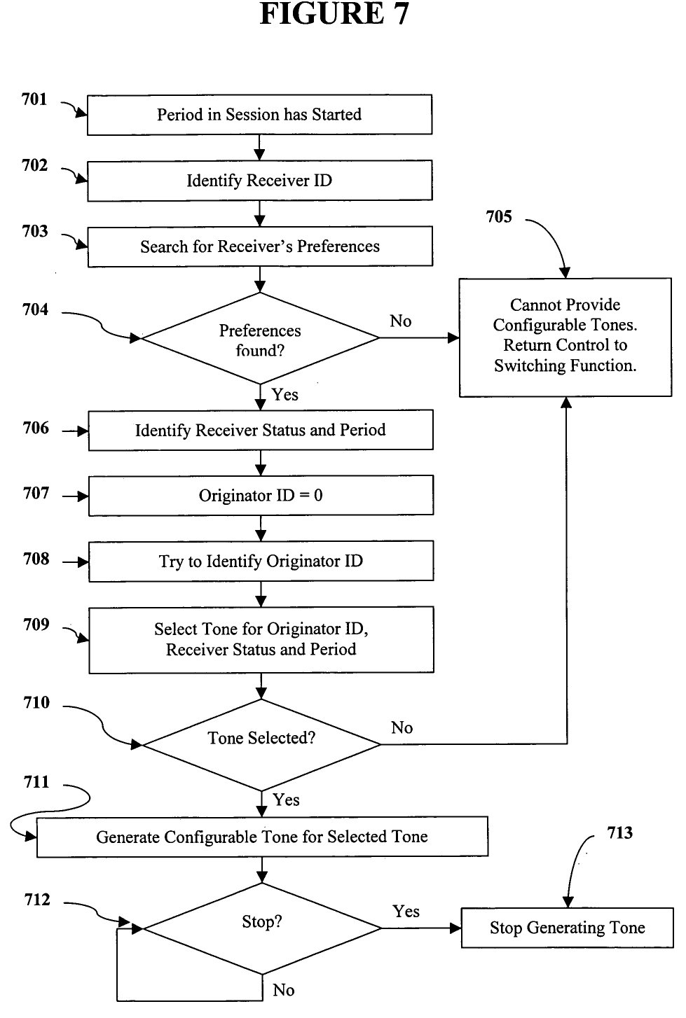

It should be noted that FIGS. 4A and 4B describes a method for storing preferences for subscribers. Description of retrieving the data is provided blow, with reference to FIG. 7.

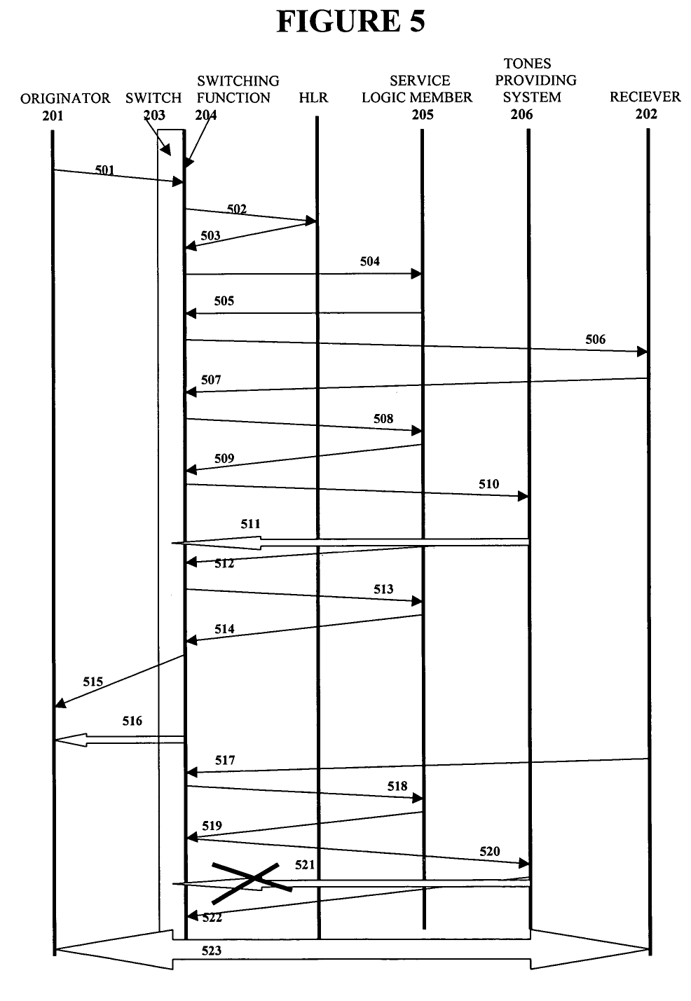

FIG. 5 illustrates a signaling flow characterizing a call to a receiver who is subscribed to the tones providing service operating in IN mode, the configurable call progress tone replaces a pending call progress tone (and more specifically, a ringback tone), according to one embodiment of the invention. When a call originator 201 calls a receiver 202, the switch 203 is contacted, and the switching function 204 associated with the switch 203 receives (501) call setup signaling. The switching function 204 verifies if the receiver is subscribed to IN services of any kind. This can be done, for example, by consulting the Home Location Register (hereinafter, HLR) as known to those versed in the art (502, 503). If the receiver is found to be subscribed to IN services (it is recalled that according to this embodiment the configurable tones providing service is an IN service) the switching function 204 inquires the service logic member 205 about call parameters. Inquiry can be done by sending (504) an INAP Session Start message and receiving a generate call reply (505), in accordance therewith the switching function 204 calls (506) the receiver and receives a reply (507) notifying it that the receiver telephone is ringing. As known to those versed in the art, when operating in accordance with signaling system number 7 (SS7) for example, the switching function 204 calls the receiver by sending an IAM message (Initial Address Message) to the switch to whom the receiver is directly connected. After receiving (507) the ringing reply, the switching function 204 notifies (508) the service logic member 205 that the receiver's telephone is ringing. In reply the switching function 204 receives (509) generate call data including also information whether the receiver is or is not subscribed to the tones providing service (as may be recalled with reference to FIG. 2, the service logic member 205 might be coupled to a database storing subscribers' records).

If the receiver is a subscriber, the switching function 204 sends (510) a start call message (such as IAM) to the tones providing system 206. The start call message includes information about the receiver, about the caller ID (if such information is available) and about the receiver's status (“ringing” according to this example). The tones providing system 206 locates the receiver's preferences, retrieves the selected content accordingly, and starts streaming (511) the selected content to the switch 203. In parallel, the tones providing system 206 returns a response message (512), such as ACM in SS7 (Address Completion Message) notifying the switching function 204 that a configurable tone is being provided.

The switching function 204 sends (513) an event report to the service logic member 205, notifying it that the configurable tone is being provided, and receives (514) a reply instructing it to connect the tones providing system 206 and the originator 201. The switching function 204 sends (515) a ringing message to the originator 201, and streams the provided configurable content to him (516).

When the receiver 202 answers the call, the switching function 204 receives (517) an answer message indicative thereof. The switching function 204 sends (518) an event report to the service logic member 205, notifying it that the call was answered. The switching function 204 receives (519) a reply from the service logic member 205, instructing it to stop providing the tone and to connect the originator 201 and the receiver 202. The switching function 204 sends (520) a release message to the tones providing system 206, which stops (521) streaming the provided content, and sends a message indicative thereof to the switching function 204. The switching function 204 receives (522) the message and connects (523) the originator and the receiver, enabling them to conduct a conversation.

It should be noted that those skilled in the art can appreciate that the receiver can be connected via another switch being part of the session's switching system, or by the same switch 203 operating the switching function 204. In the same way, those skilled in the art realize how to perform steps such as calling the receiver (506), receiving an answer indication (517) or connecting the originator and the receiver (523).

Those versed in the art will readily appreciate that the signaling flow illustrated in FIG. 5 is by no means binding. Accordingly, the signaling flow and/or timing and/or the order of performing the steps thereof may be modified and/or other signals and steps may be added, all as required and appropriate depending upon the particular application.

Moreover, whereas FIG. 5 illustrated a signaling flow that relates to a configurable ringback tone, those versed in the art can appreciate that other configurable tones can be provided, being pending or fail call progress tones, mutatis mutandis.

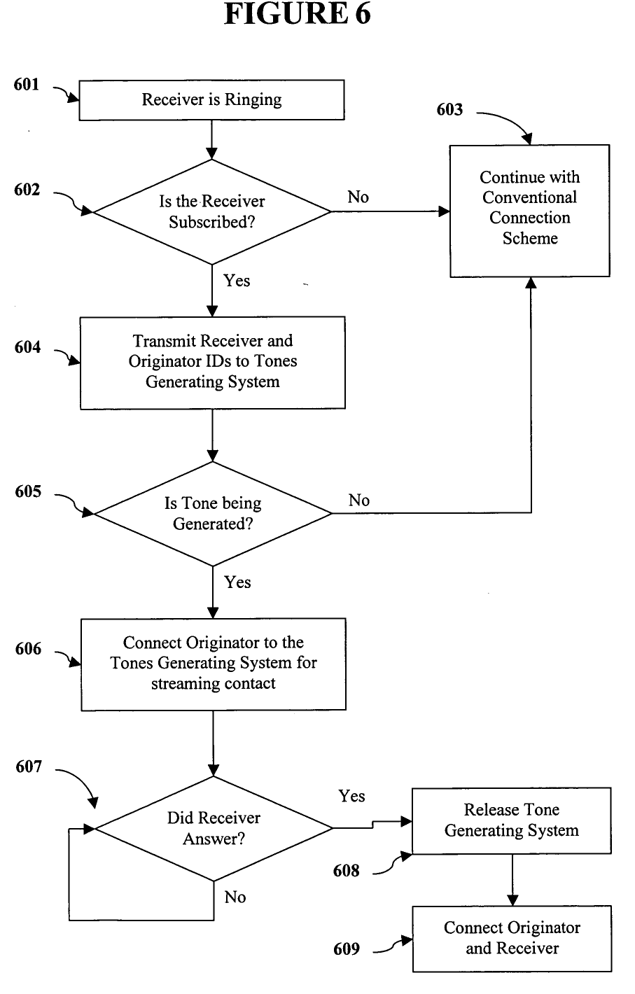

FIG. 6 is a flow chart illustrating a switching function 204 operating in IN mode, according to one embodiment of the invention. The illustrated embodiment is based on the signaling scheme illustrated in FIG. 5.

In 601 the switching function 204 receives the indication that the receiver's telephone is ringing (507). The switching function inquires then, in 602, whether the receiver is subscribed to the tones providing service. This can be done by sending an inquiry to the service logic member 205 (refer to 508 and 509 in FIG. 5). If the receiver is not a subscriber, the switching function continues with a conventional connection scheme, as known to those skilled in the field (603). However, if the receiver is a subscriber, on 604 the switching system connects to the tones providing system 206, transmitting the receiver's identification (and if available, also the originator's identification) to it (510 and 512 in FIG. 5). If on 605 a configurable tone isn't being provided by the tones providing system the switching function continues with a conventional connection scheme (603) as known to those skilled in the field. Yet, if on 605 the switching system determines that a configurable tone is provided by the tones providing system, on 606 it connects the originator 201 to the tones providing system 206 to receive the streamed content therefrom. One exemplary way for connecting the originator to the tones providing system for receiving content is illustrated by 513-516 in FIG. 5.

When on 607 the switching function detects that the receiver has answered the call, on 608 it releases the connection between the originator and the tones providing system (see for example, FIG. 5, 517-522). Then on 609 it connects the originator 201 to the receiver 202.

Turning now to FIG. 7 that is a flow chart of the operating steps in a tones providing system, according to one embodiment of the invention, when the tones providing system receives information that a session has started, 701 (see also 510 in FIG. 5), it identifies the receiver (e.g., according to the receiver's telephone number, as dialed by the originator) of the session, for example, by extracting the receiver ID from data provided to the tones providing system, 702, and searches for the receiver's preferences, 703. On 704 the tones providing system checks whether the receiver's preferences were found. If not, the system can not provide a configurable tone for the session, therefore it returns control (705) to the switching function, to continue providing conventional call progress tones therefore. It should be recalled that storing preferences in the preferences storage 306 was described with reference to FIG. 4.

After successfully extracting the receiver's preferences, on 706 the tones providing system identifies the receiver's status and the period, i.e., a duration of said receiver status during which the configurable tone should be provided (e.g. by extracting identifying data from data provided to the tones generating service). On 707 the originator ID is set to a default value (for example, zero), and on 708 the tones providing system tries to identify the actual originator ID to replace the default value. It is noted that if the originator ID cannot be identified, the default value set on 707 stays active.

Next, the tones providing system tries to select a configurable tone (709) in accordance with the receiver's preferences. Selection is done according to the receiver status, the period and to the originator ID (if different than zero). If on 710 it is found that no tone could be selected, for example because there is no configurable tone (personalized or not) set for the period, the tones providing system cannot provide a configurable tones providing service for this session, and it returns control (705) to the switching function, to continue providing conventional call progress tones.

After selecting a tone, the tones providing system retrieves the respective content, providing the configurable tone (711). The configurable tone is provided as long as the stop condition is not meet (712). Meeting the stop condition is, for instance, when the period terminates or when the receiver answers the call (as signaled by the switching function). When the stop condition is meet, the tones providing system stops providing the configurable tone.

It is noted that the flow chart in FIG. 7 is provided by way of a non-limiting example, and other ways for providing a configurable ringback tone in a tones providing system are also available and applicable. For example, it is assumed in FIG. 7 that the switching function notifies the tones providing system when a period starts or terminates. However, those versed in the art can appreciate that the tones providing system can integrate into the suggested method the possibility of time allocation, thereby weakening the dependency on the switching function. Moreover, those versed in the art will readily appreciate that the flow chart of FIG. 7 is by no means binding and accordingly one or more of the steps illustrated thereby may be modified and/or others may be added, all as required and appropriate depending upon the particular application.

It should be noted that according to other embodiments, there can be several periods, or several (at least one) durations of a receiver status, as seen in FIG. 1. It can be appreciated from the description above that it is possible to provide different tones (configurable or conventional) during the different periods.

Having described the tones providing system in accordance with various embodiments of the invention there follows a description (with reference to FIG. 8) of a simplified tones providing system operating in combination with a voice mail system, according to one embodiment of the present invention.

Specifically, FIG. 8 illustrates a block diagram of a tones providing system operating in combination with a voice mail system according to an embodiment of the invention. Similar to the embodiment that was described with reference to FIG. 3, the current embodiment of the tones providing system 206 can also have several modules associated therewith, where the modules communicate through a network 801. The tones providing system 206 can have one or more storage devices 802, and different interfaces 803, for example, a web/WAP interface (that can be similar to the web/WAP interface 309 in FIG. 3). An application server 804 is in charge for managing preferences and when a session starts, it is responsible for locating the subscriber's preferences and selecting the tone. The application server 804 is coupled to the switching function 204 (not shown) via a computer communication network 805, all as shown and described in more details with reference to FIG. 3.

In this embodiment, a voice mail system 806 is also coupled to the tones providing system 206. As known to those versed in the art, voice mail systems have access to E1/T1 trunks 807, and usually they are also capable of restoring data from a content storage (such as messages retrieved by their receivers). Therefore, those versed in the art can appreciate that it is possible to provide configurable tones from within the voice mail system 806 instead of providing it from within the application server 804, simplifying it thereby. At the same time, as voice mail systems 806 can have access to E1/T1 trunks 807, it might be possible to avoid having a telephony interface associated with the tones providing system, such as the telephony interface 302 of FIG. 3. This simplifies the tones providing system even further.

When using the voice mail system 806 for providing tones, the application server 804 selects a selected tone, wherein the voice mail system 806 is in charge for retrieving the respective content and for providing the respective configurable tone. According to a different embodiment, the application server can be coupled to a content storage. After selecting a tone, the application server can select a tone, retrieve retrieving the respective content and provide it to the voice mail system (for example, by streaming the data over the communication network 801. The voice mail system 806 receives the configurable call progress tone, and provides it to the switching system over the E1/T1 trunks.

It can be appreciated that certain embodiments can have a content storage coupled to the voice mail system 806, or a content storage being part of the storage device 802, or a combination thereof.

Those versed in the art will readily appreciate that the block diagram of FIG. 8 is by no means binding and accordingly one or more of the components thereof may be modified and/or others may be added, all as required and appropriate depending upon the particular application.

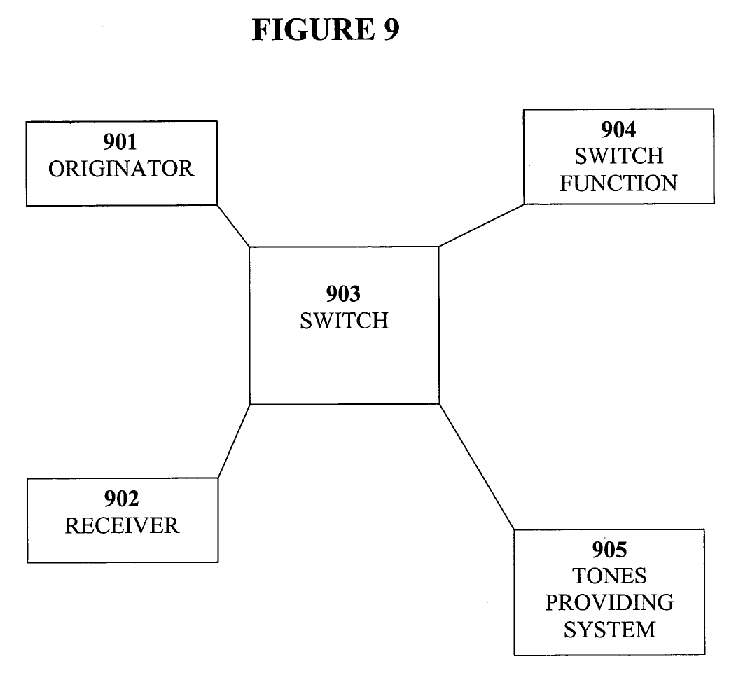

FIG. 9 illustrates a block diagram of a tones providing system operating in service node configuration according to an embodiment of the invention. An originator 901 calls a receiver 902 via a switch 903 included in a switching system (not shown). The switch is coupled to a switching function 904. A tones providing system 905 is also coupled to the switch 903.

Functionally, the service node configuration provides two optional modes of operation. In one mode, referred to hereinafter as a fixed-bridge mode, the tones providing system 905 is used to manage calls when the receiver 902 is subscribed to the tones providing service. In the fixed-bridge mode, the tones providing system 905 manages the calls until they are disconnected and their session terminates. By doing this, the tones providing system 905 provides functionality similar to the switching function 904.

On the other hand, in the second mode, referred to hereinafter as drop-back mode, the tones providing system 905 provides a configurable tone, and when the receiver answers the call, the tones providing system 905 transmits an event message to the switching function 904, transmitting control to it thereby. After receiving the event message, the switching function 904, receives control over the call, managing it until its session terminates.

The above and other features of the invention including various and novel method steps has been particularly described with reference to the accompanying drawings and pointed out in the claims. It will be understood that the particular method for providing configurable call progress tones embodying the invention is shown by way of illustration only and not as a limitation of the invention. The principles and features of this invention may be employed in varied and numerous embodiments without departing from the scope of the invention.

1. A method for providing configurable call progress tones in a telephony session, the method comprising:
identifying a receiver of said telephony session;
selecting a tone in accordance with preferences; said preferences are dependent upon at least said receiver identity; and
providing a configurable call progress tone of said selected tone.

2. The method of claim 1, further comprising identifying at least one receiver status of said telephony session, wherein said preferences are further dependent upon a receiver status of said at least one receiver status.

3. The method of claim 2, further comprising:
identifying a change in said at least one receiver status, giving rise to new receiver status;
selectively selecting a new tone in accordance with preferences; said preferences are dependent upon at least said receiver identity and upon said new receiver status; and
in case a new tone was selected, providing a new configurable call progress tone of said new selected tone.

4. The method of claim 1, further comprising identifying at least one period of said telephony session, wherein said preferences are further dependent upon a period of said at least one period.

5. The method of claim 2, further comprising identifying at least one period for any duration of a receiver status from among said at least one receiver status, wherein said preferences are further dependent upon a period of said at least one period.

6. The method of claim 2, comprising:
identifying at least one additional period;
selecting a tone in accordance with said preferences that further depend upon a period selected from among said at least one period and said at least one additional period; and
providing a conventional call progress tone of said selected tone in accordance with a receiver status from said at least one receiver status.

7. The method of claim 6, wherein said conventional call progress tone is a member of a group that comprises a busy tone, a call waiting tone and a ringback tone.

8. The method of claim 5, comprising:
identifying at least one additional period within the duration of said receiver status;
selecting a tone in accordance with said preferences that further depend upon at least a period from among said at least one period and at least one additional period; and
providing a conventional call progress tone of said selected tone in accordance with the receiver status.

9. The method of claim 8, wherein said conventional call progress tone is a member of a group that comprises a busy tone, a call waiting tone and a ringback tone.

10. The method according to claim 1, wherein said provided configurable tone is at least one member of a group that comprises an audio, a video, an interactive program and a recorded tone.

11. The method according to claim 2, wherein said provided configurable tone is at least one member of a group that comprises an audio, a video, an interactive program and a recorded tone.

12. The method according to claim 4, wherein said provided configurable tone is at least one member of a group that comprises an audio, a video, an interactive program and a recorded tone.

13. The method according to claim 6, wherein said provided configurable tone is at least one member of a group that comprises: an audio, a video, an interactive program and a recorded tone.

14. The method of claim 1, further comprising identifying an originator of said telephony session, wherein said preferences are further dependent upon said originator identity.

15. The method according to claim 14, wherein said provided configurable tone is at least one member of a group that comprises an audio, a video, an interactive program and a recorded tone.

16. The method of claim 2, further comprising identifying an originator of said telephony session, wherein said preferences are further dependent upon said originator identity.

17. The method of claim 2, further comprising identifying an originator of said telephony session, wherein said preferences are further dependent upon said originator identity.

18. The method of claim 6, further comprising identifying an originator of said telephony session, wherein said preferences are further dependent upon said originator identity.

19. A method for providing configurable call progress tones in a telephony session, the method comprising:
identifying an originator of said telephony session;
selecting a tone in accordance with preferences; said preferences are dependent upon at least said originator identity; and
providing a configurable call progress tone of said selected tone after paging to a receiver.

20. The method of claim 19, further comprising identifying a receiver of said telephony session, wherein said preferences are further dependent upon said receiver identity.

21. The method of claim 1, wherein identifying a receiver is according to a member in a group that comprises a receiver telephone number and a receiver UPN.

22. The method of claim 14, wherein identifying a receiver is according to a member in a group that comprises a receiver telephone number and a receiver UPN.

23. The method of claim 20, wherein identifying a receiver is according to a member in a group that comprises a receiver telephone number and a receiver UPN.

24. A method for providing configurable call progress tones in a telephony session, the method comprising:
identifying at least two parties of said telephony session;
selecting a tone in accordance with preferences; said preferences are dependent upon at least one identity of said at least two parties identities; and
providing a configurable call progress tone of said selected tone after paging to a receiver.

25. A method for providing configurable call progress tones in a telephony session, the method comprising:
identifying at least two parties of said telephony session;
selecting a tone in accordance with preferences; said preferences are dependent upon said at least two identities of said at least two parties identities; and
providing a configurable call progress tone of said selected tone.

26. A method for providing configurable call progress tones in a telephony session, the method comprising:
identifying a receiver of said telephony session;
identifying a receiver status of said telephony session;
selecting a tone in accordance with preferences; said preferences are dependent upon at least said receiver identity;
providing a configurable call progress tone of said selected tone; and
providing in association with said configurable call progress tone a conventional call progress tone in accordance with said receiver status.

27. The method of claim 26, wherein said association is preceding in time to said provided configurable call progress tone.

28. The method of claim 26, wherein said association is interleaved with said provided configurable call progress tone.

29. The method of claim 26, wherein said association is superimposed on said provided configurable call progress tone.

30. The method of claim 26, further comprising identifying an originator of said telephony session, wherein said preferences are further dependent upon said originator identity.

31. The method of claim 30, wherein said association is preceding in time to said provided configurable call progress tone.

32. The method of claim 30, wherein said association is interleaved with said provided configurable call progress tone.

33. The method of claim 30, wherein said association is superimposed on said provided configurable call progress tone.

34. A method for providing configurable call progress tones in a telephony session, the method comprising:
identifying an originator of said telephony session;
identifying a receiver status of said telephony session;
selecting a tone in accordance with preferences; said preferences are dependent upon at least said originator identity;
providing a configurable call progress tone of said selected tone after paging to a receiver; and
providing in association with said configurable call progress tone a conventional call progress tone in accordance with said receiver status.

35. The method of claim 34, wherein said association is preceding in time to said provided configurable call progress tone.

36. The method of claim 34, wherein said association is interleaved with said provided configurable call progress tone.

37. The method of claim 34, wherein said association is superimposed on said provided configurable call progress tone.

38. The method of claim 34, further comprising identifying a receiver of said telephony session, wherein said preferences are further dependent upon said receiver identity.

39. A system in association with a switching system for providing configurable call progress tones in a telephony session, the system comprising:
a module identifying a receiver of said telephony session;
a module selecting a tone in accordance with preferences; said preferences are dependent upon at least said receiver identity; and
a module providing a configurable call progress tone of said selected tone.

40. A system in association with a switching system for providing configurable call progress tones in a telephony session, the system comprising:
module identifying an originator of said telephony session;
module selecting a tone in accordance with preferences; said preferences are dependent upon at least said originator identity; and
module providing a configurable call progress tone of said selected tone after paging to a receiver.

41. A system in association with a switching system providing configurable call progress tones in a telephony session, the system comprising:
a service logic module identifying at least two parties of said telephony session;
a tone providing module selecting a tone in accordance with preferences; said preferences are dependent upon at least two identities of said at least two parties identities; and
a connection module providing a configurable call progress tone of said selected tone.

42. A system in association with a switching system for providing configurable call progress tones in a telephony session, the system comprising:
a module identifying a receiver of said telephony session;
a module identifying a receiver status of said telephony session;
a module selecting a tone in accordance with preferences; said preferences are dependent upon at least said receiver identity;
a module providing a configurable call progress tone of said selected tone; and
a module providing in association with said configurable call progress tone a conventional call progress tone in accordance with said receiver status.

43. A system in association with a switching system for providing configurable call progress tones in a telephony session, the system comprising:
a storage module storing an identity of an originator of said telephony session and preferences corresponding to said identity,
a processing module identifying said originator identity and selecting a tone in accordance with said preferences; and
wherein said processing module further transmits a configurable call progress tone of said selected tone to a receiver and transmits a conventional call progress tone.

44. A tones providing system for providing configurable call progress tones in a telephony session, the tones providing system is configured to perform at least the following:
identify a receiver of said telephony session;
select a tone in accordance with preferences; said preferences are dependent upon at least said receiver identity; and
provide a configurable call progress tone of said selected tone.

45. The tones providing system of claim 44 wherein said tones providing system comprises:
at least one application server,
at least one storage device;
at least one telephony interface; and
a communication network coupling said application server, said storage device and said telephony interface,
wherein said storage device is configured to store preferences of tone selections and data associated with said tones selections;
wherein said at least one application server is configured to identify said receiver of said telephony session, selecting said tone in accordance with preferences stored in said storage devices, and conveying said configurable call progress tone stored in said storage devices to said telephony interface; and
wherein said telephony interface is configured to provide said call progress tone.

46. The tones providing system of claim 44 further being associated with a switching system.

47. The tones providing system of claim 46 wherein said tones providing system is configured to provide said configurable call progress tone to said switching system; and said switching system is configured to provide said configurable call progress tone to said receiver.

48. The tones providing system of claim 46 further being associated with a voice mail system.

49. The tones providing system of claim 48 wherein said tones providing system is configured to provide said configurable call progress tone to said voice mail system; and said voice mail system is configured to provide said configurable call progress tone to said switching system.

50. The tones providing system of claim 48 wherein said tones providing system is configured to select said tone, providing said selected tone to said voice mail system; and said voice mail system is configured to provide a configurable call progress tone of said selected tone to said switching system.

51. The tones providing system of claim 50 wherein said tones providing system and said switching system operate in an intelligent network configuration.

52. The tones providing system of claim 50 wherein said tones providing system and said switching system operate in a service node configuration.

53. A system for providing configurable call progress tones in a telephony session, the system comprising:
a switch for receiving a call originated from a terminal;
a storage member storing at least one preference dependent upon a terminal identity; and
a server identifying at least one said preference using said storage member,
wherein said switch device sends a query to said server to select a tone in accordance with said at least one preference; and
wherein said server provides a configurable call progress tone of selected said tone to said terminal via said switch.

54. An article of manufacture comprising a program readable by a computer and embodying one or more instructions executable by the computer to perform a method, comprising:
identifying a receiver of said telephony session;
selecting a tone in accordance with preferences; said preferences depend upon at least said receiver identity; and
providing a configurable call progress tone of said selected tone.
